(19) United States
(12) Patent Application Publication
(10) Pub. No.: US 2014/0362572 A1
(43) Pub. Date: Dec. 11, 2014

(54) LED LIGHTING DEVICE WITH HIGH-LOW BEAMS

(71) Applicant: National Central University, Taoyuan County (TW)

(72) Inventors: CHING-CHERNG SUN, TAOYUAN COUNTY (TW); JHIH-YOU CAI, TAOYUAN COUNTY (TW)

(21) Appl. No.: 13/911,260

(22) Filed: Jun. 6, 2013

(51) Int. Cl. F21V 7/00; F21V 13/04

(52) U.S. Cl. CPC F21V 7/0083; F21V 13/04
USPC 362/245; 362/247

(57) ABSTRACT

A LED lighting device includes a cooling base having an assembling surface defined at a bottom thereof, a first LED chip and a second LED chip assembled on the assembling surface, a reflecting member facing the assembling surface, the reflecting member having a high beam reflector and a low beam reflector, the high beam reflector and the low beam reflector respectively corresponding to the second LED chip and the first LED chip, and a curvature of the high beam reflector being different from a curvature of the low beam reflector. Wherein, light beams from the second LED chip are reflected by the high beam reflector toward a far region relative to the LED lighting device of the present invention; light beams from the first LED chip are reflected by the low beam reflector toward a close region relative to the LED lighting device of the present invention.

### BACKGROUND OF THE INVENTION

1. Field of the Invention

The present invention relates to a LED lighting device, and more particularly to a LED lighting device with high-low beams.

2. Description of Related Art

A conventional lighting device with high-low beams comprises a light source, a reflector and an adjusting structure. When the conventional lighting device is switched to a high beam mode or a low beam mode, the adjusting structure adjusts a position of the light source relative to the reflector so as to adjust an incident angle of light beams from the light source; as a result, the light beams from the light source can be reflected by the reflector toward a close region or a far region relative to the conventional lighting device.

Another conventional lighting device with high-low beams comprises a light source, a reflector and an adjusting structure. When the conventional lighting device is switched to a high beam mode or a low beam mode, the adjusting structure adjusts an azimuth angle of the reflector relative to the light source so as to adjust an incident angle of light beams from the light source; as a result, the light beams from the light source can be reflected by the reflector toward a close region or a far region relative to the conventional lighting device.

However, the adjusting structure of said conventional lighting device is usually very precise and liable to fault. In addition, the conventional lighting device is complicated and the cost of the conventional lighting device is increased, because of the adjusting structure.

The present invention has arisen to mitigate and/or obviate the disadvantages of the conventional.

### SUMMARY OF THE INVENTION

The main objective of the present invention is to provide an improved LED lighting device.

To achieve the objective, a LED lighting device with high-low beams comprises a cooling base having an assembling surface defined at a bottom thereof, a first LED chip and a second LED chip assembled on the assembling surface, a gap defined between the first LED chip and the second LED chip, a reflecting member facing the assembling surface, the reflecting member having a high beam reflector and a low beam reflector, the high beam reflector and the low beam reflector respectively corresponding to the second LED chip and the first LED chip, and a curvature of the high beam reflector being different from a curvature of the low beam reflector. Wherein, the assembling surface of the cooling base is completely plane; the high beam reflector is closer to the assembling surface than the low beam reflector; the LED lighting device further comprises a lens, and the lens is assembled in front of the high beam reflector of the reflecting member; the lens might be a plano-convex lens, a biconvex lens or a Fresnel lens; the cooling base is made of copper or aluminum.

Under this arrangement, light beams from the second LED chip are reflected by the high beam reflector toward a far region relative to the LED lighting device of the present invention; light beams from the first LED chip are reflected by the low beam reflector toward a close region relative to the LED lighting device of the present invention.

Further benefits and advantages of the present invention will become apparent after a careful reading of the detailed description with appropriate reference to the accompanying drawings.

### BRIEF DESCRIPTION OF THE DRAWINGS

FIG. 1 is a side view of the present invention;

FIG. 2 is a side view of the present invention for showing light beams from the first LED chip;

FIG. 3 is a side view of the present invention for showing light beams from the second LED chip;

FIG. 4 is a side view of the present invention for showing the light beams from the first LED chip and the light beams from the second LED chip; and

FIG. 5 is a side view of the present invention for showing a lens.

### DETAILED DESCRIPTION OF THE INVENTION

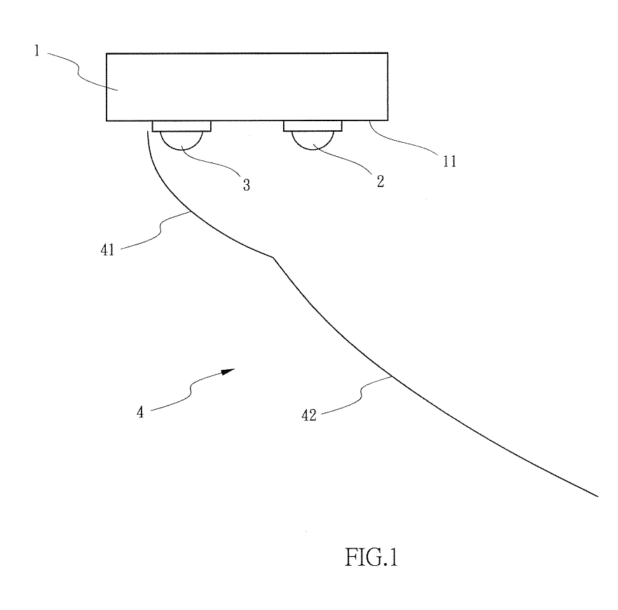

Referring to FIGS. 1-3, a LED lighting device with high-low beams in accordance with the present invention comprises a cooling base 1, a first LED chip 2, a second LED chip 3 and a reflecting member 4. The cooling base 1 has an assembling surface 11 defined at a bottom thereof. The first LED chip 2 and the second LED chip 3 are assembled on the assembling surface 11. A gap is defined between the first LED chip 2 and the second LED chip 3. The reflecting member 4 faces the assembling surface 11. The reflecting member 4 has a high beam reflector 41 and a low beam reflector 42. The high beam reflector 41 and the low beam reflector 42 respectively correspond to the second LED chip 3 and the first LED chip 2. A curvature of the high beam reflector 41 is different from a curvature of the low beam reflector 42. Light beams from the second LED chip 3 are reflected by the high beam reflector 41 toward a far region relative to the LED lighting device of the present invention. Light beams from the first LED chip 2 are reflected by the low beam reflector 42 toward a close region relative to the LED lighting device of the present invention.

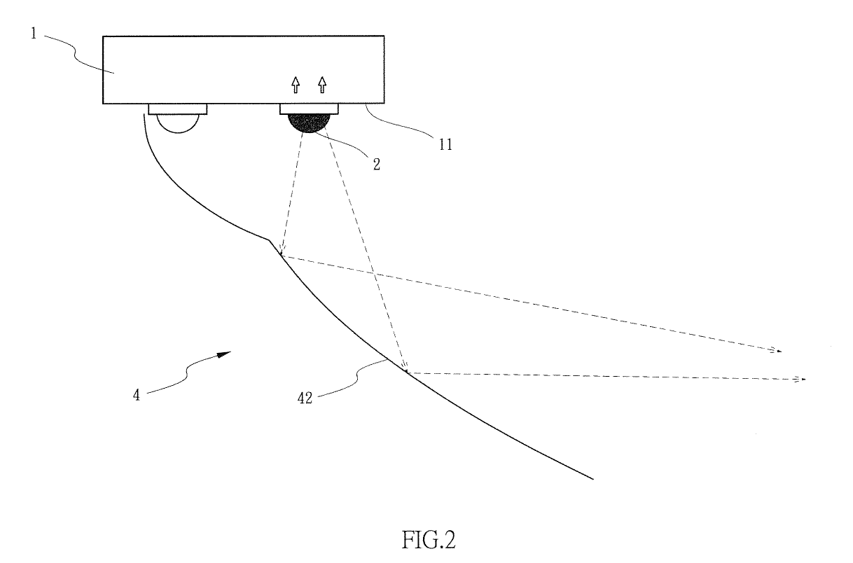

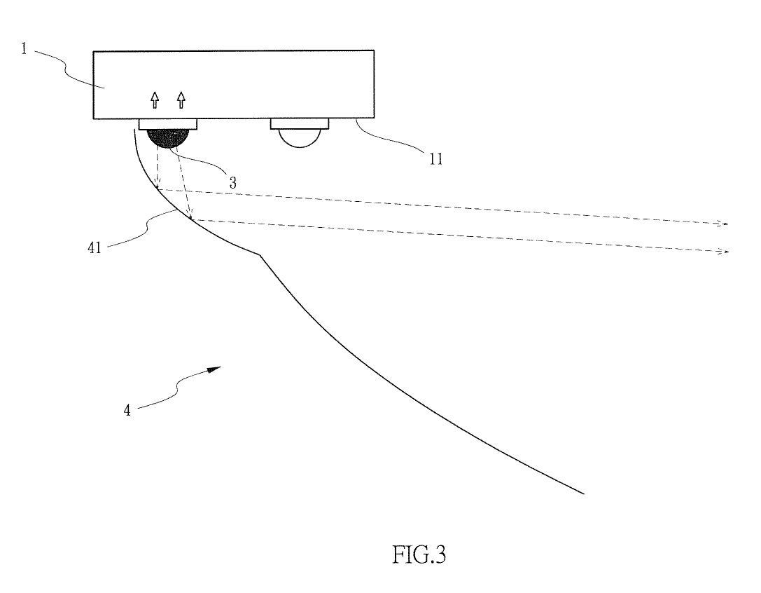

Referring to FIG. 2, when the LED lighting device of the present invention is switched to a low beam mode, the first LED chip 2 is turned on; the light beams from the first LED chip 2 (as shown in FIG. 2) are reflected by the low beam reflector 42 toward the close region relative to the LED lighting device of the present invention. Referring to FIG. 3, when the LED lighting device of the present invention is switched to a high beam mode, the second LED chip 3 is turned on; the light beams from the second LED chip 3 (as shown in FIG. 3) are reflected by the high beam reflector 41 toward the far region relative to the LED lighting device of the present invention. In addition, because the first LED chip 2 and the second LED chip 3 are both assembled at the cooling base 1, the heat emitted from the first LED chip 2 or the second LED chip 3 is transmitted to the outside relative to the LED lighting device of the present invention via the cooling base 1; therefore, the first LED chip 2 or the second LED chip 3 is prevented from being overheated.

Under this arrangement, a user can selectively switch the LED lighting device of the present invention to one of the low beam mode and the low beam mode, via selectively turning on one of the second LED chip 3 and the first LED chip 2. Therefore, the adjusting structure of the LED chip or the reflecting member is not necessary for the present invention; the whole structure of the present invention is simpler than that of the conventional LED lighting device.

Furthermore, the assembling surface 11 of the cooling base 1 is completely plane, so that the second LED chip 3 and the first LED chip 2 assembled on the assembling surface 11 are located in the same plane. Therefore, the heat emitted from the first LED chip 2 or the second LED chip 3 would be efficiently transmitted to the outside relative to the LED lighting device of the present invention. The high beam reflector 41 is closer to the assembling surface 11 than the low beam reflector 42. The cooling base 1 is made of a thermal conductive material which is selected from a group consisting of copper and aluminum.

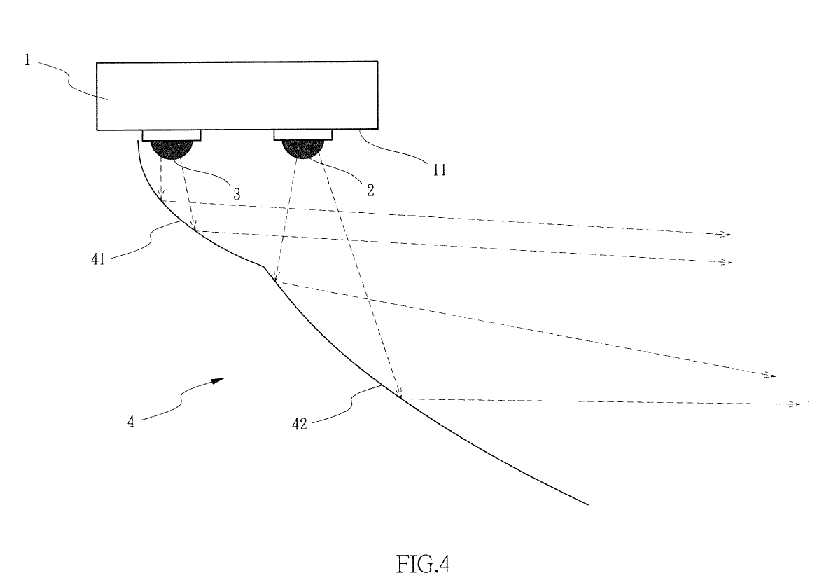

Referring to FIG. 4, when the second LED chip 3 and the first LED chip 2 are simultaneously turned on, the light beams from the first LED chip 2 are reflected toward the close region relative to the LED lighting device of the present invention; simultaneously, the light beams from the second LED chip 3 are reflected toward the far region relative to the LED lighting device of the present invention. Therefore, the close region and the far region relative to the LED lighting device of the present invention are simultaneously lighted up by the present invention.

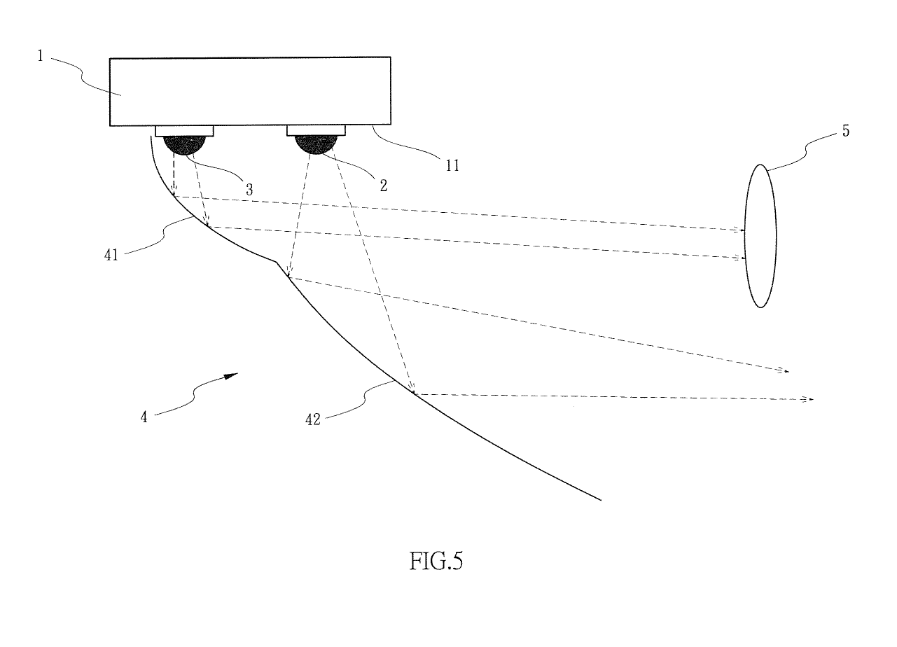

Referring to FIG. 5, the LED lighting device of the present invention further comprises a lens 5. The lens 5 is assembled in front of the high beam reflector 41 of the reflecting member 4, so that the lens 5 corresponds to the light beams reflected by the high beam reflector 41. The lens 5 can further focus the light beams reflected by the high beam reflector 41. The lens 5 is selected from a group consisting of a plano-convex lens, a biconvex lens and a Fresnel lens.

Although the invention has been explained in relation to its preferred embodiment, it is to be understood that many other possible modifications and variations can be made without departing from the spirit and scope of the invention as hereinafter claimed.

What is claimed is:

1. A LED lighting device comprising:
a cooling base having an assembling surface defined at a bottom thereof;
a first LED chip and a second LED chip assembled on the assembling surface and spaced from each other; and
a reflecting member facing the assembling surface, the reflecting member having a high beam reflector and a low beam reflector, the high beam reflector and the low beam reflector respectively corresponding to the second LED chip and the first LED chip, a curvature of a surface of the high beam reflector being different from a curvature of a surface of the low beam reflector;
wherein, light beams from the second LED chip are reflected by the high beam reflector toward a far region; light beams from the first LED chip are reflected by the low beam reflector toward a close region.

2. The LED lighting device with high-low beams as claimed in claim 1, wherein the assembling surface of the cooling base is completely plane.

3. The LED lighting device with high-low beams as claimed in claim 1, wherein the high beam reflector is closer to the assembling surface than the low beam reflector.

4. The LED lighting device with high-low beams as claimed in claim 3, further comprising a lens, the lens assembled in front of the high beam reflector of the reflecting member.

5. The LED lighting device with high-low beams as claimed in claim 4, wherein the lens is selected from a group consisting of a plano-convex lens, a biconvex lens and a Fresnel lens.

6. The LED lighting device with high-low beams as claimed in claim 1, wherein the cooling base is made of a material selected from a group consisting of copper and aluminum.
